(19) United States
(12) Patent Application Publication
(10) Pub. No.: US 2019/0227473 A1
(43) Pub. Date: Jul. 25, 2019

(54) RECORDING SHEET CHARACTERISTICS SENSING DEVICE AND IMAGE FORMING APPARATUS

(71) Applicant: Konica Minolta Inc., Tokyo (JP)

(72) Inventors: Takashi GONDA, Toyokawa-shi (JP); Shogo ASAOKA, Toyokawa-shi (JP)

(21) Appl. No.: 16/255,117

(22) Filed: Jan. 23, 2019

(30) Foreign Application Priority Data
Jan. 25, 2018 (JP) 2018-010208

(51) Int. Cl. G03G 15/00

(52) U.S. Cl. CPC G03G 15/5062

(57) ABSTRACT

A recording sheet characteristics sensing device includes: a transmitted-light source that emits light onto a principal surface of a recording sheet being conveyed; a transmitted-light quantity detector that measures a quantity of transmitted light having passed through the recording sheet, the transmitted light being of the light emitted by the transmitted-light source; a transmitted-light diaphragm that has a diaphragm hole and limits the transmitted light entering the transmitted-light quantity detector to the transmitted light having passed through the diaphragm hole; and a sensor that senses characteristics of the recording sheet being conveyed, using the quantity of transmitted light detected by the transmitted-light quantity detector, wherein the diaphragm hole is narrower in a conveying direction than in a direction perpendicular to the conveying direction.

### CROSS-REFERENCE TO RELATED APPLICATION

The present application claims priority under 35 U.S.C. § 119 to Japanese Patent Application No. 2018-010208, filed on Jan. 25, 2018, the entirety of which is hereby incorporated by reference herein and forms a part of the specification.

### BACKGROUND

### Technological Field

The present invention relates to a recording sheet characteristics sensing device and an image forming apparatus, and move particularly, to a technology for preventing decrease in sensing accuracy due to flapping of a recording sheet.

### Description of the Related Art

An electrophotographic image forming apparatus of today is capable of forming high-quality images on a wide variety of paper sheets by switching image forming conditions such as the sheet conveyance velocity and the toner image fixing temperature. Therefore, there is a method of setting image forming conditions by prompting a user to select a paper type, and lowering the sheet conveyance velocity or increasing the toner image fixing temperature if the basis weight or the thickness of the selected paper sheet is great, for example.

However, a user does not always know the types of paper sheets set in paper feed cassettes and a paper feed tray. Therefore, it is not always easy to select an appropriate paper type. If a wrong paper type is selected, a paper jam might occur, or it might become difficult to form a high-quality image.

To counter this, JP 2005-070508 A discloses an image forming apparatus that sets image forming conditions by emitting light onto a paper sheet and detecting the quantity of transmitted light and the quantity of reflected light. The quantity of transmitted light becomes smaller as the basis weight and the thickness of the paper sheet becomes greater. Further, the quantity of transmitted light also becomes smaller when the whiteness of the paper sheet is low or the color of the paper sheet is dark.

On the other hand, the quantity of reflected light is not affected by the basis weight and the thickness of the paper sheet, but becomes smaller when the whiteness of the paper sheet is low or the color of the paper sheet is dark. Therefore, according to this conventional technique, the contribution of the whiteness and the color tone is subtracted from the detected quantity of transmitted light in accordance with the quantity of reflected light, and image forming conditions are set in accordance with the basis weight and the thickness of the paper sheet estimated from the detected value after the subtraction. In this manner, erroneous setting by the user can be avoided. Thus, paper jams can be prevented, and high-quality image formation can be achieved.

To estimate the basis weight and the thickness of a paper sheet without any decrease in the productivity (the number of images formed per unit time) of the image forming apparatus, it is preferable to detect the quantity of transmitted light in the paper feed path during the period from delivery of the paper sheet from a paper feed cassette till the electrostatic transfer of a toner image onto the paper sheet.

In a case where the paper feed passage is straight, the shape of the paper sheet remains flat, and accordingly, the quantity of transmitted light can be detected with high accuracy. However, in a case where the density of components mounted in the apparatus is increased to reduce the size of the image forming apparatus, it is difficult to maintain a straight paper feed path, and the paper feed path is inevitably curved. Since the position and the shape of a paper sheet change in a curved paper feed path, the quantity of transmitted light fluctuates, and the basis weight detection accuracy becomes lower.

To counter this, JP 2008-094600 A discloses a conventional technique for reducing flapping by pressing a paper sheet with a lever. Where flapping of paper sheets is prevented in this manner, the accuracy of transmitted light quantity detection can be increased.

However, if a lever is used to reduce flapping of paper sheets, or if the paper feed path is narrowed, conveyance of the paper sheets is hindered. Particularly, if the paper feed path is narrowed over a long distance along the paper feed path, skew or the like might occur, and there is a possibility that the paper conveyance performance will be adversely affected.

On the other hand, if the area in which the quantity of transmitted light is measured is narrowed, the surfaces of recording sheets are easily affected by variation due to locations. Therefore, the quantity of transmitted light is preferably measured in the largest possible area.

### SUMMARY

The present invention has been made in view of the above problems, and an object thereof is to provide a recording sheet characteristics sensing device and an image forming apparatus that are less affected by flapping of paper sheets and variation in the surfaces of paper sheets when detecting the sheet characteristics to be used in determining a paper type.

To achieve the abovementioned object, according to an aspect of the present invention, a recording sheet characteristics sensing device reflecting one aspect of the present invention comprises: a transmitted-light source that emits light onto a principal surface of a recording sheet being conveyed; a transmitted-light quantity detector that measures a quantity of transmitted light having passed through the recording sheet, the transmitted light being of the light emitted by the transmitted-light source; a transmitted-light diaphragm that has a diaphragm hole and limits the transmitted light entering the transmitted-light quantity detector to the transmitted light having passed through the diaphragm hole; and a sensor that senses characteristics of the recording sheet being conveyed, using the quantity of transmitted light detected by the transmitted-light quantity detector, wherein the diaphragm hole is narrower in a conveying direction than in a direction perpendicular to the conveying direction.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram showing the principal structure of an image forming apparatus according to a first embodiment of the present invention;

FIG. 2 is a diagram showing the principal structure of a sheet characteristics sensing device;

FIG. 3A is a cross-sectional view in a cross-section perpendicular to the main scanning direction of the sheet characteristics sensing device;

FIG. 3B is a cross-sectional view in a cross-section perpendicular to the sub scanning direction;

FIG. 3C is a plan view of a sensor diaphragm;

FIG. 3D is a plan view of a light source diaphragm;

FIG. 4A is a plan view of the light source diaphragm;

FIG. 4B is a plan view of the sensor diaphragm;

FIG. 4C is a graph showing the relationship between the position of a passing recording sheet and the transmission output, for each diaphragm diameter of the light source diaphragm;

FIG. 5A is a cross-sectional view in a cross-section perpendicular to the main scanning direction of a sheet characteristics sensing device according to a third embodiment of the present invention;

FIG. 5B is a cross-sectional view in a cross-section perpendicular to the sub scanning direction;

FIG. 5C is a plan view of a sensor diaphragm; and

FIG. 5D is a plan view of a shared diaphragm.

### DETAILED DESCRIPTION OF EMBODIMENTS

Hereinafter, one or more embodiments of a recording sheet characteristics sensing device and an image forming apparatus according to the present invention will be described with reference to the drawings. However, the scope of the invention is not limited to the disclosed embodiments.

### [1] First Embodiment

An image forming apparatus according to this embodiment characteristically improves sensing accuracy by emitting sensing light onto a specific area of a recording sheet when optically sensing the characteristics of the recording sheet.

(1-1) Structure of an Image Forming Apparatus

First, the structure of the image forming apparatus according to this embodiment is described.

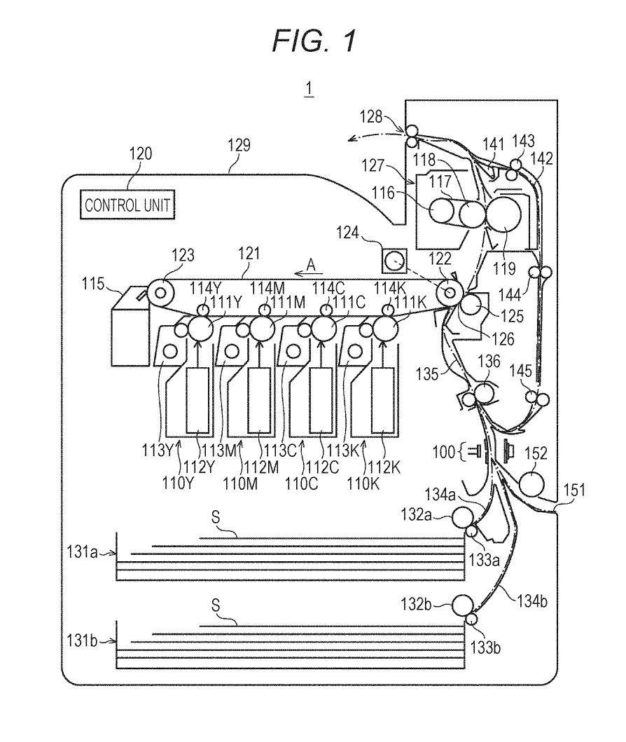

As shown in FIG. 1, the image forming apparatus 1 according to this embodiment is a so-called tandem color printer.

The image forming apparatus 1 forms toner images in the respective colors of yellow (Y), magenta (M), cyan (C), and black (K), using image forming units 110Y, 110M, 110C, and 110K. The image forming units 110Y, 110M, 110C, and 110K include photosensitive drums 111Y, 111M, 111C, and 111K, exposure devices 112Y, 112M, 112C, and 112K, developing devices 113Y, 113M, 113C, and 113K, charging devices (not shown), and cleaning devices (not shown), respectively.

The charging device uniformly charges the outer peripheral surfaces of the photosensitive drums 111Y, 111M, 111C, and 111K, and the exposure devices 112Y, 112M, 112C, and 112K form electrostatic latent images by irradiating the outer peripheral surfaces of the photosensitive drums 111Y, 111M, 111C, and 111K with laser light modulated according to digital image data of the respective color components. The developing devices 113Y, 113M, 113C, and 113K supply toner of the respective colors Y, M, C, and K, to visualize the electrostatic latent images and form toner images in the respective colors Y, M, C, and K.

An intermediate transfer belt 121 is an endless belt, and is stretched around a driving roller 122, a driven roller 123, and primary transfer rollers 114Y, 114M, 114C, and 114K. The intermediate transfer belt 121 rotationally moves in the direction indicated by an arrow A, as a motor 124 rotates the driving roller 122. A secondary transfer roller 125 is pressed against the driving roller 122, with the intermediate transfer belt 121 interposed in between. With this arrangement, a secondary transfer nip 126 is formed.

The primary transfer rollers 114Y, 114M, 114C, and 114K electrostatically transfer the toner images in the respective colors Y, M, C, and K onto the intermediate transfer belt 121 from the photosensitive drums 111Y, 111M, 111C, and 111K at such timings that the toner images in the respective colors overlap one another. As a result, a color toner image is formed. After the primary transfer, the cleaning device neutralizes the charges remaining on the outer peripheral surfaces of the photosensitive drums 111Y, 111M, 111C, and 111K, scrapes off the residual toner, and disposes of the residual toner.

Paper feed cassettes 131a and 131b that store recording sheets S are installed in a lower portion of the image forming apparatus 1. Paper feed rollers 132a and 132b sent out the recording sheets S from the paper feed cassettes 131a and 131b, respectively. When the recording sheets S are being sent out, separating rollers 133a and 133b prevent feeding of two or more recording sheets S at once. The recording sheets S delivered from the paper feed cassettes 131a and 131b are conveyed to a sheet conveyance path 135 via the sheet conveyance paths 134a and 134b, respectively. Recording sheet S supplied from a manual feed tray (not shown) are conveyed from a sheet conveyance path 151 to the sheet conveyance path 135 by a manual feed roller 152.

The sheet characteristics sensing device 100 is disposed on the downstream side of the junction of the sheet conveyance paths 134a, 134b, and 151, and on the upstream side of a registration roller pair (sometimes referred to as a timing roller pair) 136 in the sheet conveyance path 135. The sheet characteristics sensing device 100 optically senses the characteristics of a recording sheet S passing through the sheet conveyance path 135.

In this embodiment, so-called center feeding is performed on the recording sheets S, so that each recording sheet S passes through the central portion of the sheet conveyance path 135 in the width direction of the recording sheets S. The sheet characteristics sensing device 100 is disposed in the central portion in the width direction of the recording sheets S (the direction perpendicular to the direction of conveyance of the recording sheets S), and is capable of optically sensing the characteristics of the recording sheets S, regardless of the sizes of the recording sheets S.

Further, in the vicinity of the position at which the sheet characteristics sensing device 100 is disposed, the sheet conveyance path 135 is substantially straight, and thus, flapping of the recording sheets S is reduced.

When reaching the registration roller pair 136, a recording sheet S comes into contact with the stopped registration roller pair 136, and forms a loop. As a result, skew correction is performed.

After that, when the color toner image is conveyed to the secondary transfer nip 126 by the rotation of the intermediate transfer belt 121, the registration roller pair 136 starts rotating, and the recording sheet S is conveyed to the secondary transfer nip 126. The secondary transfer roller 125 electrostatically transfers the color toner image from the intermediate transfer belt 121 onto the recording sheet S (secondary transfer).

After the secondary transfer, a cleaning device 115 scrapes off the toner remaining on the intermediate transfer belt 121, and disposes of the residual toner. The recording sheet S is conveyed to a fixing device 127. The fixing device 127 includes a heating roller 116, a fixing belt 117, a fixing roller 118, and a pressure roller 119. The heating roller 116 is heated by a heater (not shown), to heat the fixing belt 117 to a fixing temperature.

The fixing belt 117 is an endless belt, and rotates with the fixing roller 118. The fixing roller 118 is rotationally driven by a motor (not shown). The pressure roller 119 is pressed against the fixing roller 118, with the fixing belt 117 being interposed in between. As a result, a fixing nip is formed. When the recording sheet S passes through the fixing nip, the color toner image is thermally fixed to the recording sheet S.

After the fixing, the recording sheet S is ejected onto a catch tray 129 on the image forming apparatus 1 by ejection rollers 128. In a case where two-side printing is performed, the recording sheet S is reversed in the sheet conveying direction by the ejection rollers 128, is conveyed to a paper refeed path 142 by a claw 141, and is then conveyed to the registration roller pair 136 by conveyance roller pairs 143, 144, and 145. After that, a color toner image is transferred onto the back surface of the recording sheet S at the secondary transfer nip 126, the toner image is thermally fixed by the fixing device 127, and is ejected onto the catch tray 129.

A control unit 120 receives a print job from an external device such as a personal computer (PC), determines image forming conditions such as a sheet conveyance velocity and a fixing temperature in accordance with the results of sensing performed by the sheet characteristics sensing device 100, and causes the image forming apparatus 1 to perform an image forming process under these image forming conditions.

In a case where the recording sheet S to be newly used in image formation is conveyed to the registration roller pair 136 via the paper refeed path 142, the sheet characteristics sensing device 100 is preferably disposed on the downstream side of the junction of the paper refeed path 142 and the sheet conveyance path 135.

(1-2) Sheet Characteristics Sensing Device 100

Next, the sheet characteristics sensing device 100 is described.

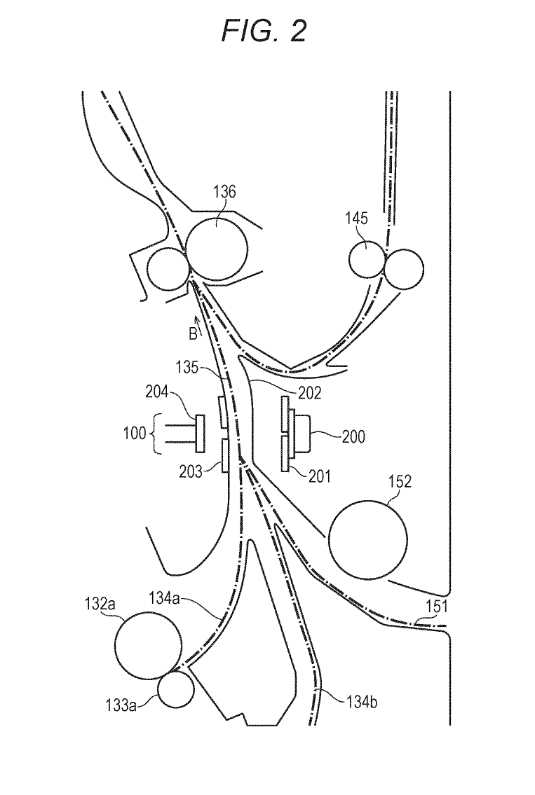

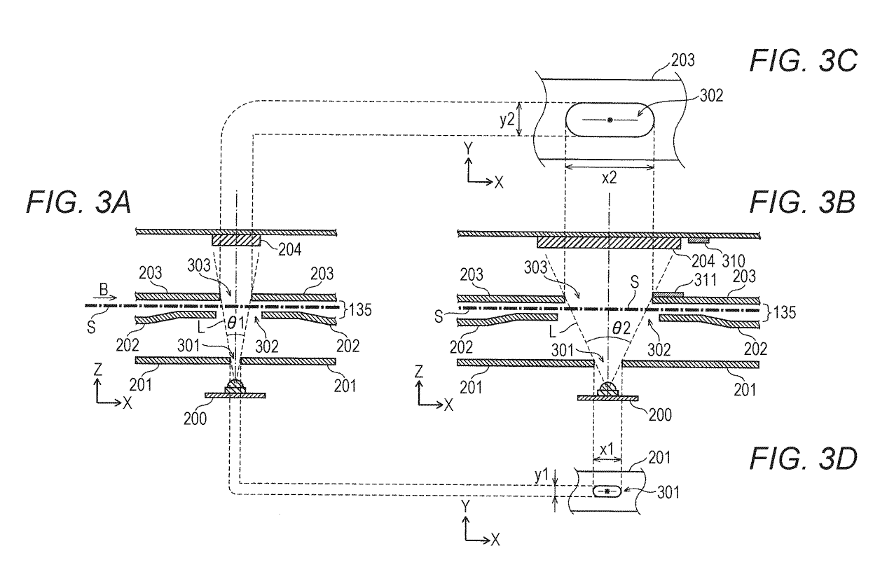

As shown in FIG. 2 and FIG. 3A to FIG. 3D, the sheet characteristics sensing device 100 includes a transmitted-light source 200, a light quantity detection sensor 204, and a reflected-light source 310. The transmitted-light source 200 is a so-called light emitting diode (LED), and emits beam light (hereinafter referred to as “transmitted-light beam light”) L to a recording sheet S. As shown in FIG. 3C, the light source diaphragm 201 has a through hole (hereinafter referred to as a “light source diaphragm hole”) 301 formed therein, to regulate the irradiation area of the transmitted-light beam light L. The surface of the light source diaphragm 201 facing the sheet conveyance path 135 is black, and prevents generation of stray light. Note that the side of the light source diaphragm 201 facing the transmitted-light source 200 may also be black. With such arrangement, the effect to prevent generation of stray light can be further enhanced.

The size x1 of the light source diaphragm hole 301 in the main scanning direction (the X-direction, which is the same as the sheet width direction) is larger than the size y1 of the light source diaphragm hole 301 in the sub scanning direction (the Y-direction, which is the same as the sheet conveying direction), as shown below.

x1>y1 (1)

Accordingly, the light source diaphragm hole 301 is long in the main scanning direction (the X-direction). Therefore, an irradiation angle θ1 viewed from the main scanning direction (the X-direction) of the transmitted-light beam light L is smaller than an irradiation angle θ2 viewed from the sub scanning direction (the Y-direction), as shown below.

θ1<θ2 (2)

Although FIG. 3C shows the light source diaphragm hole 301 having two round ends in the main scanning direction, the shape of the light source diaphragm hole 301 is of course not limited to this shape. For example, the light source diaphragm hole 301 may have a substantially rectangular shape or an elliptical shape.

Conveyance guides 202 and 203 guide the recording sheet S in the sheet conveyance path 135. The recording sheet S is conveyed along the conveyance guides 202 and 203. Specifically, the recording sheet S is conveyed in the direction indicated by an arrow B in FIG. 3A, and is conveyed in a direction perpendicular to the paper in FIG. 3B.

The conveyance guide 202 on the side of the transmitted-light source 200 has a through hole 302 that is wider than the irradiation area of the transmitted-light beam light L in both the main scanning direction (the X-direction) and the sub scanning direction (the Y-direction). Accordingly, all the beam light having passed through the light source diaphragm 201 pass through the through hole 302, without being blocked by the conveyance guide 202. Because of this, the irradiation area of the transmitted-light beam light L on the recording sheet S is determined by the light source diaphragm 201.

A through hole (hereinafter referred to as the “sensor diaphragm hole”) 303 provided in the conveyance guide (hereinafter referred to as the “sensor diaphragm”) 203 on the side of the light quantity detection sensor 204 has a shape similar to the light source diaphragm hole 301. That is,

x2:y2=x1:y1 (3)

Here, x2 and y2 represent the sizes of the sensor diaphragm hole 303 in the main scanning direction (the X-direction) and the sub scanning direction (the Y-direction), respectively. Further, the sensor diaphragm hole 303 substantially matches the irradiation area of the transmitted-light beam light L at the position of the sensor diaphragm 203 in the direction of emission of the transmitted-light beam light L (this direction is the Z-direction, and will be hereinafter referred to as the “beam emitting direction”). Accordingly, the transmitted-light beam light L having passed through the light source diaphragm 201 enters the light quantity detection sensor 204, without being blocked by the sensor diaphragm 203. Note that the light receiving region of the light quantity detection sensor 204 is longer in the main scanning direction than in the sub scanning direction, to match the irradiation area of the transmitted-light beam light L.

The conveyance guide on the side of the light quantity detection sensor 204 does not necessarily also serve as a sensor diaphragm, and a sensor diaphragm independent of the conveyance guide on the side of the light quantity detection sensor 204 may be prepared. In such a case, to prevent the conveyance guide on the side of the light quantity detection sensor 204 from kicking the transmitted-light beam light L to be passed by the sensor diaphragm, a through hole having a sufficiently large area needs to be formed in the conveyance guide on the side of the light quantity detection sensor 204.

The side of the sensor diaphragm 203 facing the sheet conveyance path 135 is also black, to prevent generation of stray light. The side of the sensor diaphragm 203 facing the light quantity detection sensor 204 may also be black. With such arrangement, generation of stray light can be more reliably prevented.

The light quantity detection sensor 204 is a so-called photodiode. The light quantity detection sensor 204 is disposed along the principal ray of the transmitted-light beam light L so that the quantity of incident light can be detected at the position where the light quantity is the largest in the light distribution region of the transmitted-light beam light L. With this arrangement, calibration becomes easier.

The reflected-light source 310 is disposed at a position adjacent to the light quantity detection sensor 204 in the main scanning direction (the X-direction). The reflected-light source 310 emits beam light in the three colors R (red), G (green), and B (blue) (this beam light will be hereinafter referred to as “reflected-light beam light”). The control unit 120 causes the transmitted-light source 200 and the reflected-light source 310 to emit the following four kinds of beam light separately from one another: the transmitted-light beam light and the reflected-light beam light in the three colors R, G, and B. The control unit 120 does not cause the light sources to emit two or more kinds of beam light at the same time.

A reflected-light reference panel 311 is attached to the side of the sensor diaphragm 203 facing the reflected-light source 310. The reflected-light reference panel 311 is a white panel having a constant reflectance and a constant diffusivity, and is used to correct the light quantity of the beam light emitted from the reflected-light source 310. Specifically, when any recording sheet S is not being conveyed, the reflected-light source 310 is made to emit light, and feedback control is performed on the quantity of light emitted from the reflected-light source 310 in accordance with the amount of reflected light detected by the light quantity detection sensor 204. In this manner, the quantity of light to be emitted from the reflected-light source 310 can be kept constant.

If the reflected-light reference panel 311 is disposed to face a recording sheet S, the reflected-light beam light is diffusely reflected between the reflected-light reference panel 311 and the recording sheet S. Therefore, as the position of the recording sheet S changes, the quantity of transmitted light changes greatly. Further, if the reflected-light reference panel 311 is disposed to comes into contact with a recording sheet S, there is a possibility that the reflected-light reference panel 311 will become dirty or be damaged, and the functions of a white panel will be lost. Therefore, the reflected-light reference panel 311 is disposed adjacent to the light quantity detection sensor 204. With this arrangement, it is possible to avoid any inconvenience that might be caused by the reflected-light reference panel 311 facing a recording sheet S or being in contact with a recording sheet S.

When the reflected-light source 310 emits the reflected-light beam light onto the reflected-light reference panel 311 and a recording sheet S, and specular reflected light and diffuse reflected light enter the light quantity detection sensor 204, the light quantity detection sensor 204 detects the quantity of reflected light.

In the irradiation area of the transmitted-light beam light L, to minimize flapping (displacement in the beam emitting direction) of a recording sheet S, the conveyance guides 202 and 203 guide the recording sheet S so that the sheet conveyance path 135 becomes straight. Further, as shown in FIG. 3A and FIG. 3B, in the vicinity of the irradiation area of the transmitted-light beam light L, the distance between the conveyance guide 202 and the conveyance guide 203 is shorter than at any other portion both in the main scanning direction and in the sub scanning direction.

In this manner, flapping of the recording sheet S in the vicinity of the irradiation area of the transmitted-light beam light L is reduced. In this embodiment, the conveyance guide 202 is bent so that the above structure is achieved. However, the conveyance guide 203 may be bent, instead of the conveyance guide 202.

When the sheet conveyance path 135 is straight in the sheet conveying direction, it is difficult for a recording sheet S to flap. Therefore, the quantity of transmitted light hardly fluctuates, but the sheet conveyance path 135 can be made straight only in a narrow area. If the sheet conveyance path 135 has a curved shape, a recording sheet S easily flaps. When a recording sheet S flaps, the transmitted light quantity fluctuates, resulting in a decrease in the accuracy of paper type determination.

On the other hand, if the size of the light source diaphragm hole 301 is made small in the sheet conveying direction (the sub scanning direction) so that a sheet stays in a straight area in which the sheet does not easily flap, the transmitted-light beam light L can be emitted onto a recording sheet S only in the area in which the sheet conveyance path 135 is straight, and thus, fluctuations in the quantity of transmitted light due to flapping can be prevented.

Further, in the above described straight area, flapping of a recording sheet S hardly occurs at any position in the sheet width direction, and accordingly, the quantity of transmitted light hardly fluctuates. In view of this, if the light source diaphragm hole 301 is made wider in the sheet width direction, and the area in which the transmitted-light beam light L is emitted onto a recording sheet S is made wider, the quantity of transmitted light can be increased, without any decrease in the accuracy of sheet characteristics detection. Thus, even if the size of the light source diaphragm hole 301 in the sheet conveying direction is made smaller, the accuracy of transmitted-light quantity detection can be increased.

### [2] Second Embodiment

An image forming apparatus 1 according to a second embodiment has substantially the same structure as the image forming apparatus 1 according to the first embodiment, except for the shape of the light source diaphragm hole 301. The following description will focus on the difference. In this specification, like components are denoted by like reference numerals throughout the embodiments.

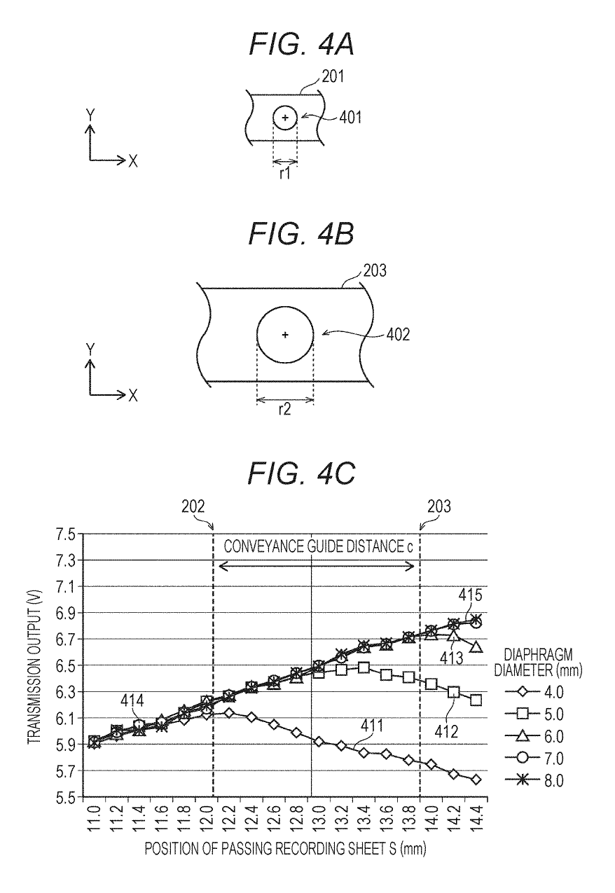

As shown in FIG. 4A, a light source diaphragm hole 401 formed in a light source diaphragm 201 according to this embodiment is a circular through hole having a diaphragm diameter r1. As shown in FIG. 4B, a sensor diaphragm hole 402 formed in a sensor diaphragm 203 is also a circular through hole, and the diaphragm diameter is r2. Accordingly, the light source diaphragm hole 401 and the sensor diaphragm hole 402 are similar to each other.

FIG. 4C shows a graph of the value of the output voltage (hereinafter referred to as the “transmission output”) of the light quantity detection sensor 204 in a case where the distance c between the conveyance guides 202 and 203 at the position closest to the irradiation area of the transmitted-light beam light L is 1.8 mm, and the position of the passing recording sheet S is changed in the beam emitting direction by 0.2 mm at a time. The graph shows the output voltage value for each diaphragm diameter in a case where the diaphragm diameter r1 of the light source diaphragm hole 401 is changed from 4.0 mm to 8.0 mm by 1.0 mm at a time.

In a case where the diaphragm diameter is 4.0 mm, the transmission output decreases from 6.15 V to 5.75 V almost in a monotonous manner, as the position of the recording sheet S moves from the light source side (the conveyance guide 202) to the sensor side (the conveyance guide 203) (line graph 411). That is, the range of fluctuation of the transmission output in a case where the recording sheet S flaps within the conveyance guide width is expressed as follows:

0.40 V=6.15 V−5.75 V (4)

In a case where the diaphragm diameter is 5.0 mm, the transmission output increases as the position of the recording sheet S moves away from the conveyance guide 202 on the light source side, and reaches the maximum value of 6.50 V at the position where the distance from the conveyance guide 202 is 13.4 mm (line graph 412). Further, as the recording sheet S moves away from the conveyance guide 202 on the light source side, and approaches the conveyance guide 203 on the sensor side, the transmission output decreases. In a case where the recording sheet S is in contact with the conveyance guide 202 on the light source side, the transmission output has the minimum value of 6.20 V. That is, the range of fluctuation of the transmission output is expressed as follows:

0.30 V=6.50 V−6.30 V (5)

In cases where the diaphragm diameter is 6.0 mm, 7.0 mm, and 8.0 mm, the transmission output has the minimum value of 6.20 V when the recording sheet S is in contact with the conveyance guide 202 on the light source side, and has the maximum value of 6.75 V when the recording sheet S is in contact with the conveyance guide 203 on the sensor side (line graphs 413, 414, and 415). Accordingly, the range of fluctuation of the transmission output is expressed as follows:

0.55 V=6.75 V−6.20 V (6)

As described above, in FIG. 4C, the range of fluctuation of the transmission output is the smallest when the diaphragm diameter is 5.0 mm. Therefore, in this embodiment, the diaphragm diameter is set at 5.0 mm, so that the range of fluctuation of the transmission output due to flapping of a recording sheet S is minimized, and the accuracy of transmitted-light quantity detection is increased.

Further, not only in a case where the light source diaphragm hole 401 has a circular shape but also in a case where the light source diaphragm hole 401 has some other shape, the range of fluctuation of the transmission output changes with the size of the diaphragm diameter. The range of fluctuation of the transmission output becomes wider when the transmission output monotonously increases or decreases as the position of the recording sheet S moves from the conveyance guide 202 on the light source side to the conveyance guide 203 on the sensor side, while the range of fluctuation of the transmission output becomes narrower in a case where the transmission output has the maximum value than in a case where the transmission output monotonously changes.

Particularly, in a case where the inclination of the graph when the transmission output increases matches the inclination of the graph when the transmission output decreases, it is possible to minimize the range of fluctuation of the transmission output by adjusting the diaphragm diameter so that the transmission output has the maximum value when the recording sheet S is located at the middle point between the conveyance guides 202 and 203. Thus, stable recording sheet characteristics sensing can be performed.

In the first embodiment described above, the light source diaphragm hole 301 and the sensor diaphragm hole 303 are not circular. However, in a case where the range of fluctuation of the transmission output varies depending on the hole diameter in the sheet width direction (the main scanning direction), it is possible to increase the sheet characteristics sensing accuracy by designing such a hole diameter as to minimize the range of fluctuation of the transmission output.

### [3] Third Embodiment

An image forming apparatus 1 according to a third embodiment has substantially the same structure as the image forming apparatus 1 according to the first embodiment, except that the transmitted-light source 200 also serves as the reflected-light source 310, and a dedicated light quantity detection sensor is provided to detect the quantity of reflected light. The following description will focus on the differences.

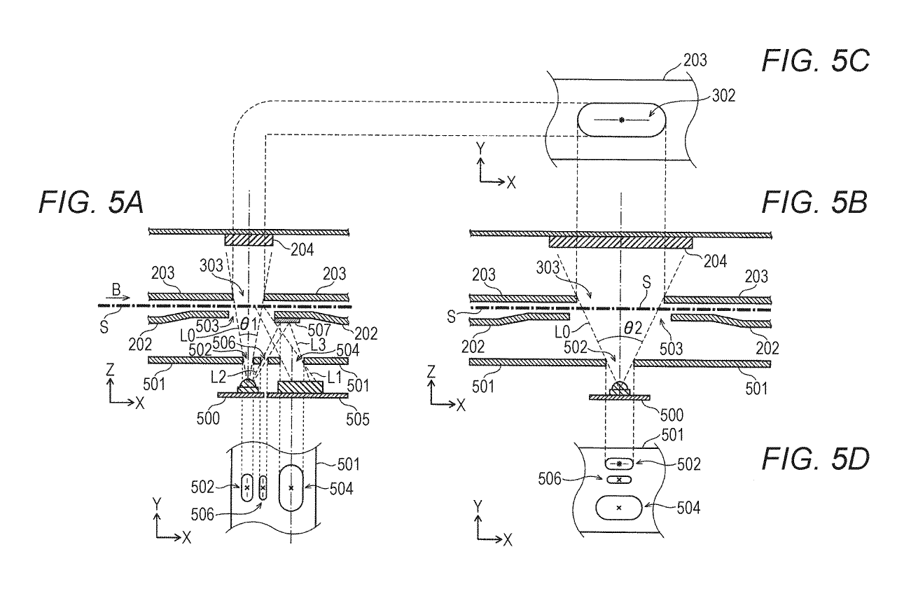

As shown in FIG. 5A, a shared light source 500 serves as a transmitted-light source and a reflected-light source. Beam light emitted from the shared light source 500 (This beam light will be hereinafter referred to as the “shared beam light L0”) enters a recording sheet S after the irradiation area is limited by a through hole 502 of a shared diaphragm 501. A through hole 503 of the conveyance guide 202 is larger than the through hole 302 in the first embodiment, and part of the shared beam light reflected by the recording sheet S (this part of the reflected light will be hereinafter referred to as the “sheet reflected light L1”) is allowed to pass through the through hole 302.

The sheet reflected light L1 further passes through a through hole 504 of the shared diaphragm 501, and enters a reflected-light sensor 505. The reflected-light sensor 505 may be a photodiode, for example.

The shared diaphragm 501 further has a through hole 506. Of the light emitted from the shared light source 500, the emitted light L2 having passed through the through hole 506 enters a reflected-light reference panel 507. The light reflected by the reflected-light reference panel 507 (this reflected light will be hereinafter referred to as the “reference panel reflected light L3”) then passes through the through hole 504 of the shared diaphragm 501, and enters the reflected-light sensor 505.

Therefore, in case where any recording sheet S is not being conveyed, only the reference panel reflected light L3 enters the reflected-light sensor 505. Further, while a recording sheet S is being conveyed, the sheet reflected light L1, as well as the reference panel reflected light L3, enters the reflected-light sensor 505. Therefore, the value obtained by dividing the value obtained by subtracting the output voltage Vs of the reflected-light sensor 505 in a case where any recording sheet S is not being conveyed (this output voltage Vs will be hereinafter referred to as the “reference output Vs”) from the output voltage Vt of the reflected-light sensor 505 by the reference output Vs is Rs, which indicates the ratio of the quantity of light reflected by the recording sheet S (Rs will be hereinafter referred to as the “reflectance”).

Rs=(Vt−Vs)/Vs (7)

Here, the quantity of light emitted from the shared light source 500 is adjusted so that the reference output Vs becomes constant. Further, as shown in FIG. 5C and FIG. 5D, the through hole 303 of the sensor diaphragm 203 has a shape similar to that of the through hole 502 of the shared diaphragm 501, and allows the shared beam light L0 to pass through the through hole 303 in a case where any recording sheet S is not being conveyed. The shared beam light L0 having passed through the through hole 303 of the sensor diaphragm 203 enters a transmitted-light sensor 204, so that the quantity of transmitted light is detected. The transmitted-light sensor 204 may be a photodiode, for example.

As shown in FIG. 5D, the size of each of the through holes 502, 504, and 506 is larger in the main scanning direction (the X-direction) than that in the sub scanning direction (the Y-direction). With this arrangement, it is possible to increase the accuracy of detection of the transmitted light quantity and the reflected light quantity, for the same reason as described in the first embodiment.

### [4] Modifications

Although embodiments of the present invention have been described so far, the present invention is of course not limited to the above described embodiments, and modifications may be made to them as described below.

(4-1) In the example cases described in the above embodiments, center feeding is performed on each recording sheet S. However, the present invention is of course not limited to these examples. In a case where one-side feeding is performed on each recording sheet S, and therefore, each recording sheet S is conveyed along one end portion of the sheet conveyance path 135 in the width direction of the recording sheet S, the sheet characteristics sensing device 100 is preferably disposed at a position close to the end portion. With this arrangement, the characteristics of each recording sheet S can be optically sensed in the case of one-side feeding, regardless of the size of the recording sheet S.

(4-2) In the example cases described in the above embodiments, the surfaces of the light source diaphragm 201 and the sensor diaphragm 203 are black. However, the present invention is of course not limited to these examples. As long as the surfaces have low reflectivity, it is possible to achieve the effect to prevent generation of stray light, even if the surfaces are not black.

(4-3) In the example cases described in the above embodiments, the sheet conveyance path 135 is substantially straight in the vicinity of the position at which the sheet characteristics sensing device 100 is disposed. However, the present invention is of course not limited to these examples. Flapping of a recording sheet S can be reduced, if the conveyance guides 202 and 203 guide the recording sheet S so that the recording sheet S becomes flat in the passing area of the transmitted-light beam light L that is to enter the light quantity detection sensor 204.

(4-4) In the example cases described in the above embodiments, the through holes 302 and 303 of the conveyance guides 202 and 203 are hollow. However, the present invention is of course not limited to these examples, and translucent flat members may be fitted in the through holes 302 and 303. In a case where the through holes 302 and 303 are hollow, a recording sheet S collides with the edges of the through holes 302 and 303. As a result, the conveyance of the recording sheet S might be hindered, or a paper jam might occur. In this modification, on the other hand, each recording sheet S can be guided in the conveying direction by the translucent flat members. Thus, hindrances to conveyance and occurrences of paper jams can be prevented.

(4-5) In the example cases described in the above embodiments, the light receiving region of the light quantity detection sensor 204 is longer in the main scanning direction than in the sub scanning direction. However, the present invention is of course not limited to these examples. The light receiving region of the light quantity detection sensor 204 may also be long in the sub scanning direction as well as in the main scanning direction. Further, photodiodes may be disposed in the main scanning direction, to cover the irradiation area of the transmitted-light beam light L.

(4-6) In the example cases described in the above embodiments, the light source diaphragm hole 301 and the sensor diaphragm hole 303 are provided only at a portion in the width direction of a recording sheet S. However, the present invention is of course not limited to these examples, and the light source diaphragm hole 301 and the sensor diaphragm hole 303 may be provided along the entire width of the recording sheet S. Where the diameters of the light source diaphragm hole 301 and the sensor diaphragm hole 303 are greater in the width direction of the recording sheet S, the quantity of light entering the light quantity detection sensor 204 can be increased to a larger quantity. Thus, it is possible to increase the accuracy in sensing the characteristics of each recording sheet S.

(4-7) In the example cases described in the above embodiments, the image forming apparatus is a tandem color printer. However, the present invention is of course not limited to these examples, and the image forming apparatus may be a color printer that is not of a tandem type, or a monochrome printer. It is also possible to achieve the same effects as above by applying the present invention to a single-function device such as a copying machine equipped with a scanner or a facsimile machine having a facsimile communication function, or to a multi-function peripheral (MFP) having those functions.

A recording sheet characteristics sensing device and an image forming apparatus according to an embodiment of the present invention are useful as devices that prevent decrease in the sensing accuracy due to flapping of recording sheets.

Although embodiments of the present invention have been described and illustrated in detail, the disclosed embodiments are made for purposes of illustration and example only and not limitation. The scope of the present invention should be interpreted by terms of the appended claims.

What is claimed is:

1. A recording sheet characteristics sensing device comprising:
a transmitted-light source that emits light onto a principal surface of a recording sheet being conveyed;
a transmitted-light quantity detector that measures a quantity of transmitted light having passed through the recording sheet, the transmitted light being of the light emitted by the transmitted-light source;
a transmitted-light diaphragm that has a diaphragm hole and limits the transmitted light entering the transmitted-light quantity detector to the transmitted light having passed through the diaphragm hole; and
a sensor that senses characteristics of the recording sheet being conveyed, using the quantity of transmitted light detected by the transmitted-light quantity detector, wherein
the diaphragm hole is narrower in a conveying direction than in a direction perpendicular to the conveying direction.

2. The recording sheet characteristics sensing device according to claim 1, wherein
the transmitted-light diaphragm includes: a light source diaphragm disposed closer to the transmitted-light source than a conveyance path of the recording sheet; and a sensor diaphragm disposed closer to the transmitted-light quantity detector than the conveyance path of the recording sheet, and
a diaphragm hole formed in the light source diaphragm and a diaphragm hole formed in the sensor diaphragm are similar in shape to each other.

3. The recording sheet characteristics sensing device according to claim 2, wherein
the diaphragm hole formed in the sensor diaphragm matches a passing area of the emitted light that has passed through the diaphragm hole formed in the light source diaphragm.

4. The recording sheet characteristics sensing device according to claim 1, wherein
a surface of the transmitted-light diaphragm is black, the surface facing the recording sheet.

5. The recording sheet characteristics sensing device according to claim 1, wherein
the recording sheet is conveyed between a pair of guide members facing each other, and one of the guide members forms the transmitted-light diaphragm at a portion facing the transmitted-light source.

6. The recording sheet characteristics sensing device according to claim 5, wherein
a distance between the pair of guide members is shorter at a position closer to a position of the emitted light passing in the conveying direction of the recording sheet.

7. The recording sheet characteristics sensing device according to claim 5, wherein
a distance between the pair of guide members is shorter at a position closer to a position of the emitted light passing in a width direction of the recording sheet.

8. The recording sheet characteristics sensing device according to claim 1, wherein
the transmitted-light source emits the light to pass through a central portion in the width direction of the recording sheet.

9. The recording sheet characteristics sensing device according to claim 1, wherein
the transmitted-light source is disposed at a position where light is emitted onto the principal surface of the recording sheet being conveyed, the position being within an area in which a conveyance path of the recording sheet is straight.

10. The recording sheet characteristics sensing device according to claim 1, wherein
when the recording sheet is conveyed from a plurality of conveyance sources, the transmitted-light source emits light onto the principal surface of the recording sheet on a downstream side of a junction of all conveyance paths from the plurality of conveyance sources in the conveying direction.

11. The recording sheet characteristics sensing device according to claim 1, further comprising:
a reflected-light quantity detector that measures a quantity of light reflected by the recording sheet; and
a reflected-light diaphragm that limits the reflected light for the reflected-light quantity detector, wherein
the reflected-light diaphragm has a shape that is narrower in the conveying direction than in a direction perpendicular to the conveying direction.

12. The recording sheet characteristics sensing device according to claim 2, further comprising:
a reflected-light quantity detector that measures a quantity of light reflected by the recording sheet; and
a reflected-light diaphragm that limits the reflected light for the reflected-light quantity detector, wherein
the sensor diaphragm serves as the reflected-light diaphragm.

13. The recording sheet characteristics sensing device according to claim 12, wherein
a portion of the reflected-light diaphragm is black, the portion facing the recording sheet.

14. An image forming apparatus comprising
the recording sheet characteristics sensing device according to claim 1, wherein
the image forming apparatus forms an image under image forming conditions suitable for recording sheet characteristics sensed by the recording sheet characteristics sensing device.

15. An image forming apparatus comprising:
the recording sheet characteristics sensing device according to claim 10; and
a plurality of sheet feeders that supply recording sheets, wherein
the image forming apparatus forms an image under image forming conditions suitable for recording sheet characteristics sensed by the recording sheet characteristics sensing device.

16. The image forming apparatus according to claim 14, further comprising:
a transfer part that transfers a toner image onto the recording sheet; and
registration rollers that are disposed on an upstream side of the transfer part in the conveyance path of the recording sheet and convey the recording sheet in time with the transfer, wherein
the recording sheet characteristics sensing device is disposed on an upstream side of the registration rollers in the conveyance path.

17. The image forming apparatus according to claim 15, further comprising:
a transfer part that transfers a toner image onto the recording sheet; and
registration rollers that are disposed on an upstream side of the transfer part in the conveyance path of the recording sheet and convey the recording sheet in time with the transfer, wherein
the recording sheet characteristics sensing device is disposed on an upstream side of the registration rollers in the conveyance path.
